(19) United States
(12) Patent Application Publication
(10) Pub. No.: US 2008/0126293 A1
(43) Pub. Date: May 29, 2008

(54) METHOD AND APPARATUS FOR DYNAMICALLY CREATING SCENARIO BASED TEST DESIGNS FROM HIERARCHICAL USE CASES

(75) Inventors: Joseph T. Apuzzo, Staatsburg, NY (US); Curtis L. Hoskins, Poughkeepsie, NY (US); Anthony F. Pioli, Shokan, NY (US); Hemant T. Suri, Poughkeepsie, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 11/534,054

(22) Filed: Sep. 21, 2006

(51) Int. Cl. G06F 17/30

(52) U.S. Cl. 707/1; 707/E17.001

(57) ABSTRACT

Use Case software analysis techniques are developed into a systematic and organized system in which elements of Use Case test scenarios are used and reused and made available from several hierarchical levels. The system is dynamic and a database of test elements are accumulated over time with system use. The invention thus not only provides the automatic, systematic and organized generation of test plans from Use Case specifications, but it also enhances an existing database of test elements over time, with use.

### TECHNICAL FIELD

This invention relates in general to testing and verification as to the correct operation of software programs. More particularly, the present invention is directed to the creation of test designs for testing and verification.

### BACKGROUND OF THE INVENTION

Software analysis involves gathering the requirements set forth in the design of a program and creating a set of scenarios, where each scenario is identified as a thread of usage for the system to be constructed. These scenarios are called “Use Cases.” They describe how the system is to be used. Use Cases improve communication patterns in a software development organization and permit the accurate description of work flow across various system uses. However, these advantages apply only to properly written Use Cases that do not include user interface details and are relatively short. This implies that, for each action in a sequence, the action that is defined may be an already existing sequence of actions that could be reused when describing another sequence of actions. Currently, this reuse is not employed and is not available in any kind of automatic or systematic fashion.

For these reasons and others, it is thus seen that, at present, Use Cases are not fully exploited. Furthermore, because of the need and desire to produce software quickly, reliably and in consonance with accelerated development schedules, if one merely follows current patterns in the employment of Use Cases, the result is seen to be counterproductive with respect to “time to market” considerations. Furthermore, even if one were to merely employ Use Case scenarios more thoroughly or pervasively, there are still opportunities for errors. For example, there can be errors in mapping Use Cases with test scenarios. There can also be errors in checking for a requirement's completeness. Furthermore, when Use Cases are created, there is no “data base” of existing Use Cases that is tapped into to help create them. Furthermore, in order to avoid discussing user interface details, while given a complete description of the Use Scenario, each Use Case writer must be experienced in “how to construct” a Use Case.

For these reasons it is seen that, while the utilization of Use Cases in software development and testing is a highly desirable goal and process, there are area in which it can be improved to shorten the development cycle even further and to do so at the same time as providing improved reliability. Additionally, software developers are provided with tools that are easier to use and which are more error free while at the same time producing a greater range and depth of Use Cases for testing.

### SUMMARY OF THE INVENTION

The shortcomings of the prior art are overcome and additional advantages are provided through the use of method for test plan creation which includes searching a first database which stores previously specified Use Cases in two or more hierarchical levels so as to identify existing test elements which are usable as part of a scenario based test design. Then, based on the content found in this database, at least one test element is selected from one of the hierarchical levels to be used in a test scenario. From these selected test elements, a test plan is created which invokes test operations for a test scenario based the Use Case specification.

Accordingly, it is an object of the present invention to expand upon the utilization of Use Cases in the analysis of software.

It is a further object of the present invention to reduce software development cycle times and to improve upon “time to market” parameters.

It is yet another object of the present invention to provide a more systematic and reliable generation of testing scenarios for software development.

It is a still further object of the present invention to provide a test tool which is dynamic and which is capable of expanding applicability with use.

Lastly, but not limited hereto, it is an object of the present invention to provide a menu driven tool for software test plan generation.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 is a flow diagram illustrating the basic steps currently employed in software testing employing Use Cases;

FIG. 2 is a block diagram illustrating the fact that in the present invention processes that were previously carried out serially are now performable in a parallel fashion; and

FIGS. 3A-3E are flow charts illustrating the process of the present invention which provides hierarchy, reusability and organization to the utilization of Use Cases.

### DETAILED DESCRIPTION

The diagrams shown in the figures provided herein show that one starts with a menu driven system for creating the Use Case(s) and produces as an end result both a Hierarchical Use Case(s) and Test Plan with actual test cases.

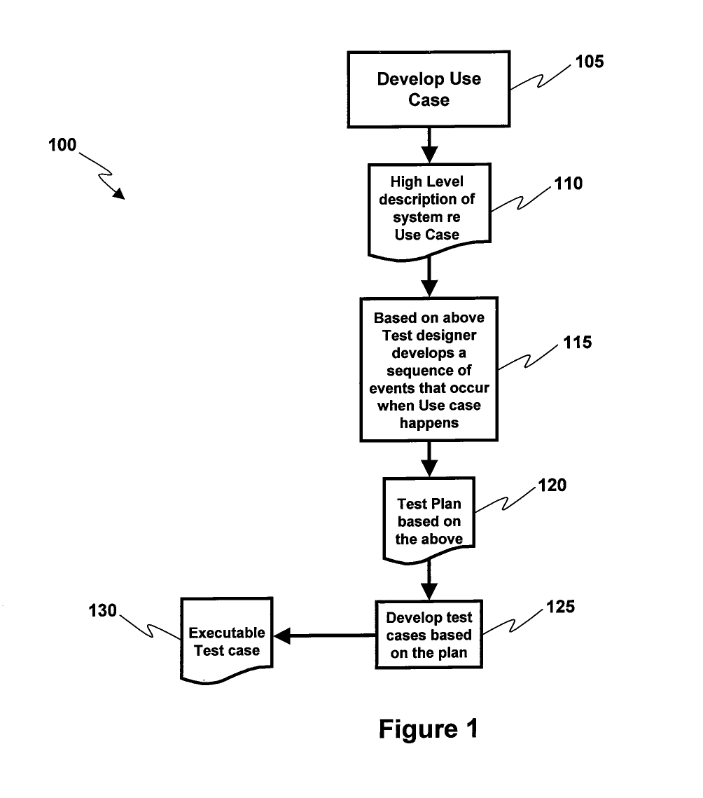

FIG. 1 illustrates a conventional approach 100 to test plan design. In FIG. 1 block 105 illustrates the fact that the input to this process is the requirements/specification document. In Use Case design, this document is effectively converted into a high level Use Case description of the design document (block 110). Thus, additional time has to be spent developing a test plan document which describes the scenarios based on the Use Case. Then, based on the high level description a test designer develops a sequence of events that occurs when a specified Use Case happens. This is shown in block 115. Often this sequence of events is derived beforehand but it is not stored anywhere, or if it is stored, it is not in an organized, systematic fashion that is in any way available for reuse. Next a test plan based on this sequence is developed (block 120). Test cases are developed based on this test plan (125) and finally an executable test case is produced (130).

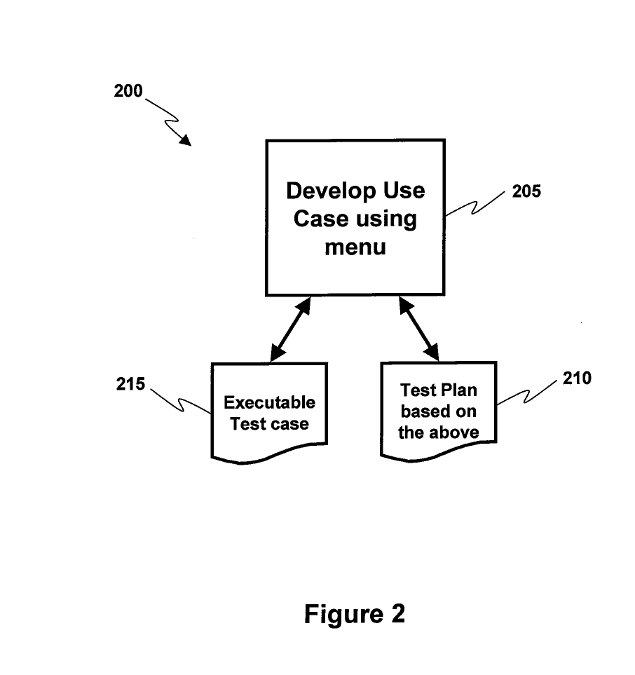

FIG. 1 clearly shows the serial nature of this process. FIG. 2, on the other hand illustrates an overview of the process 200 that results from the use of the present invention. The amount of time that it takes to create the Use Case in the conventional approach is the same (block 205), but the generation of the executable test case (block 215), and the test plan (block 210) is now created in parallel. Also the reduction and/or elimination of human error in translating the Use Case to a test scenario is provided as an added benefit. Existing executable test cases and subsequent test plans are incorporated into the data base thus creating a wealth of lower level Use Cases which can be used to build new Use Cases.

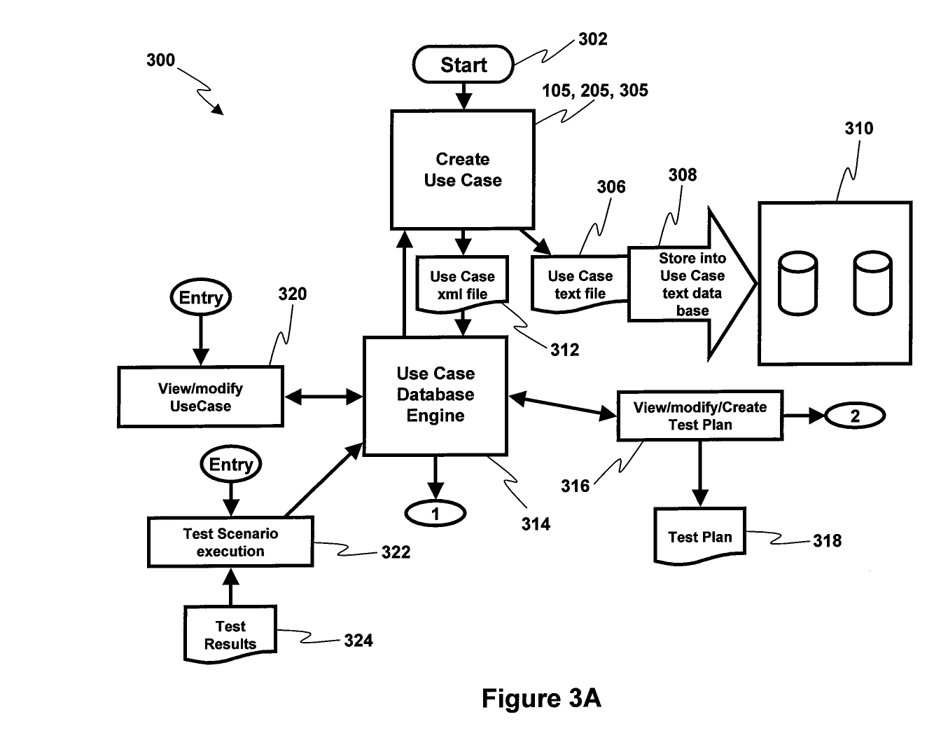

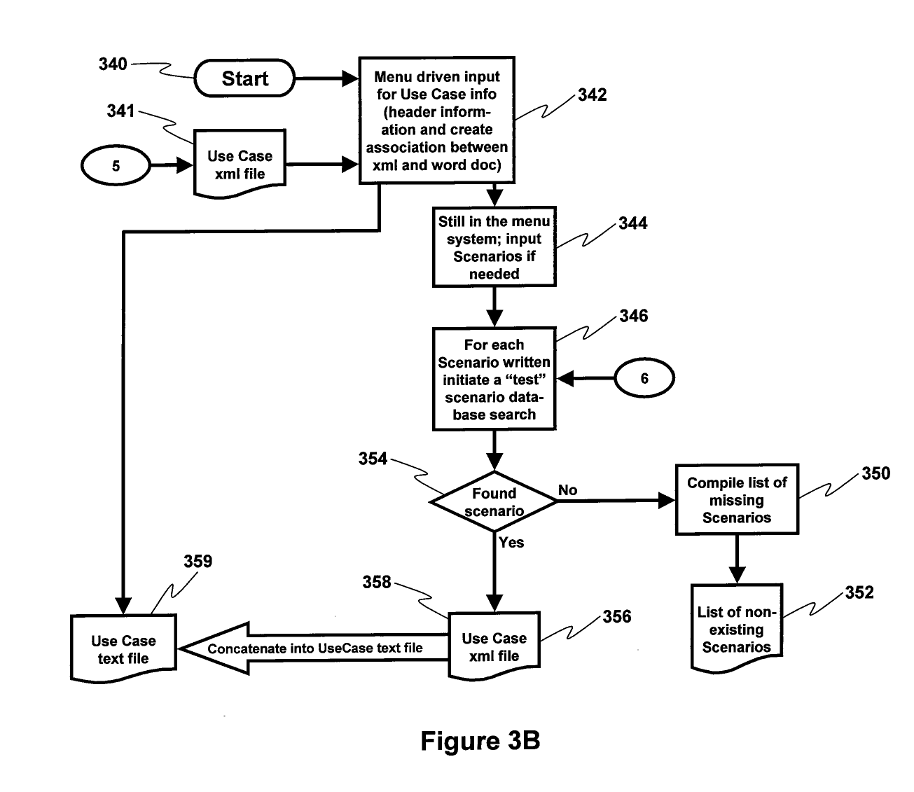

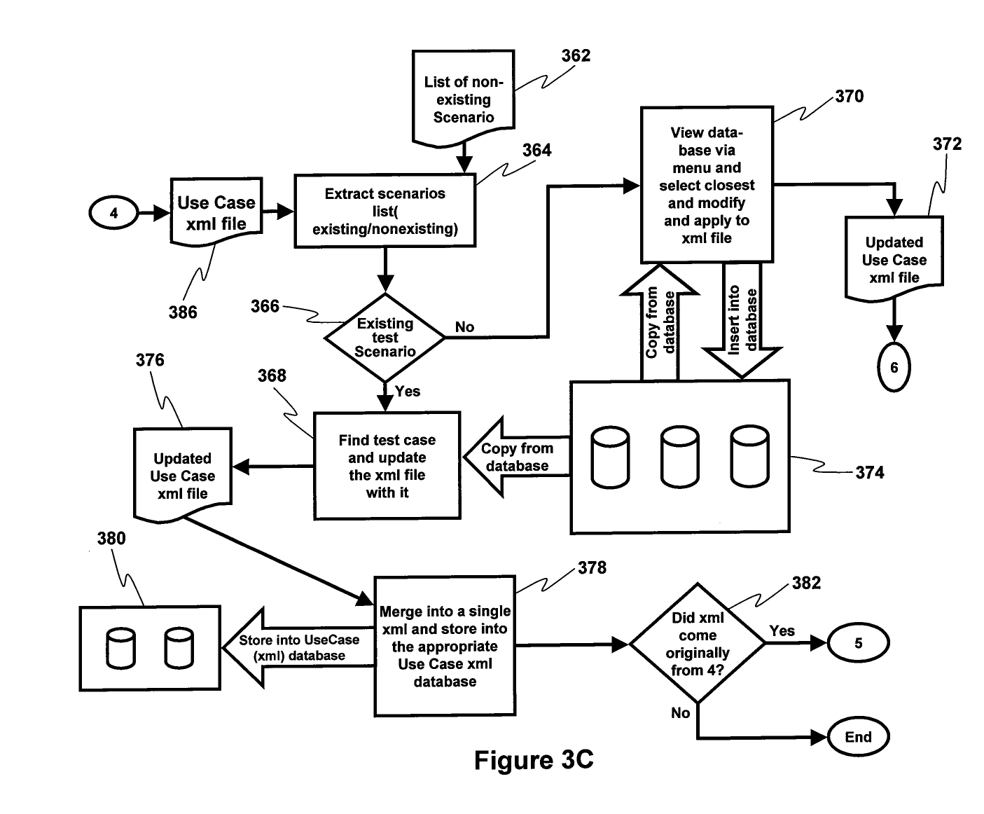

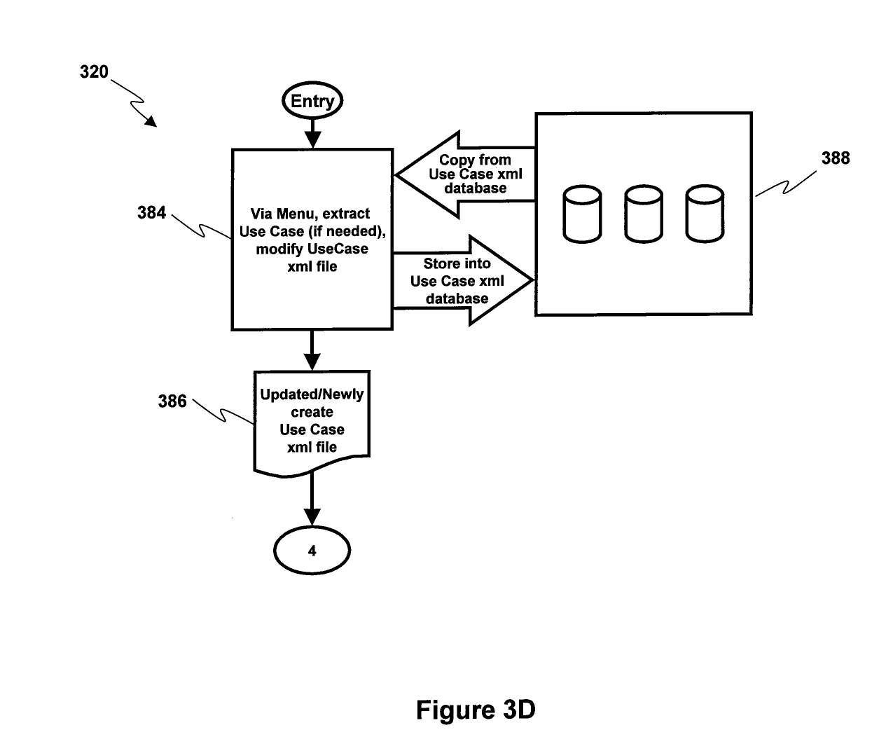

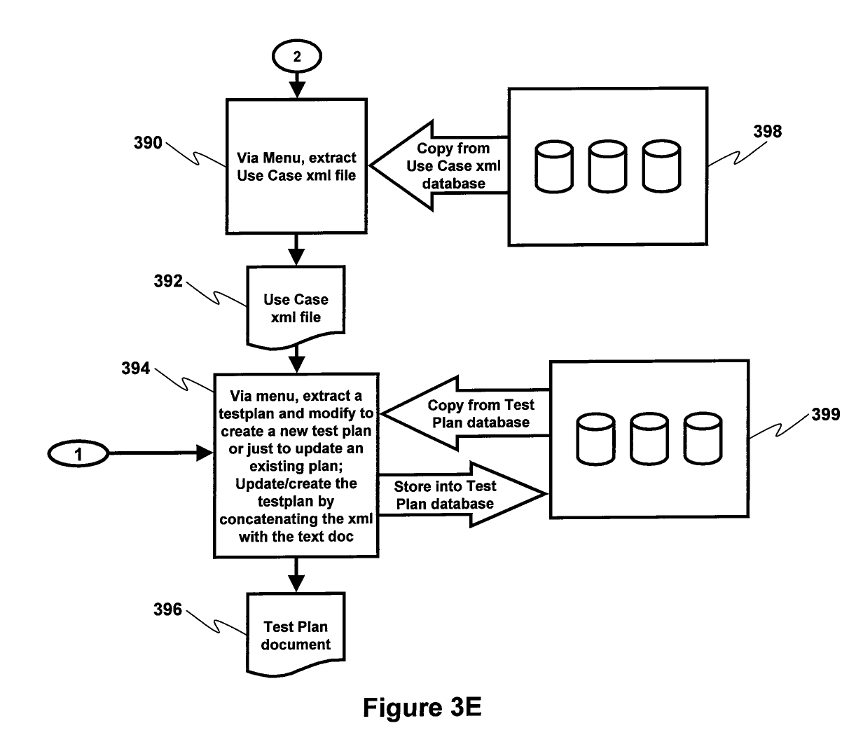

Before describing FIG. 3 in detail, it is instructive to consider how its various parts are related. FIG. 3A has a direct connection to FIG. 3E. Additionally, FIG. 3A has an indirect link to FIG. 3D. In particular, FIG. 3D is an expansion of block 320 shown in FIG. 3A. This expansion continues on in that it, in turn, is linked to FIG. 3C and FIG. 3C is linked to FIG. 3B. Merely for clarity, it is noted that there is no off-page reference numeral 3.

FIG. 3A depicts the overall flow path 300 for the activities performed in the practice of the present invention. In particular, one begins with the creation or development of a Use Case (105 in FIG. 1, 205 in FIG. 2 or, alternatively, 305 in FIG. 3A). The Use Case is savable as an xml file (312) and also in text form, for example, as text file (306). For the purpose of creating and modifying text files, it is noted that any convenient text or word processor is employable without departing from either the scope or purpose of the present invention. The text form of the Use Case file is stored (308) as part of a Use Case database file 310 for later use.

The present invention employs Use Case database engine 314. Database engine 314 is simply the mechanism that is employed to store, modify and delete entries in the databases that are employed herein. It is preferably menu driven and is provided with tools that are capable of processing test elements as they exist at various hierarchical levels. Database engine 314 is connected to block 305 to indicate that test plans and test results that it generates are employable to create future test plans and their results. This reuse is one of the significant advantages of the present invention.

Use Case database engine 314 also interacts with block 316 in which test plans are viewed, modified or created in accordance the desires of invention users which are communicated to database engine 314, preferably via menus provided. In particular, block 316 is seen as the source of one of the three basic outputs of the present invention, namely, test plan (318), the other significant outputs being test results (324) themselves and an updated/modified Use Case database (310) for either future or for continued current use.

From database engine 314 one may also enter into the processing flow shown in FIG. 3E. This is indicated by off-page reference numeral 1. Additionally, it is noted that the work flow shown in FIG. 3A has two other possible entry points. There is an entry point into block 320. As indicated above, block 320 is expanded upon in the flow path shown in FIG. 3D. The third entry point is provided via block 322 which is an entry into one or more procedures which carry out test plan (scenario) execution. These procedures may also be provided with previous test results 324. Use Case database engine 314 is capable of processing the results of this execution for present or future use. In this way, it is easier to match up test plans with test results.

Attention is next logically directed to FIG. 3E since work flow there may be entered from blocks 314 and 316 of FIG. 3A. If the user's desire is to either view, modify or create a test plan, as from block 316, the Use Case xml file is extracted 390 from the Use Case xml database 398. This operation is carried out via menu driven selection. The extracted xml file is sent for processing to block 394. Via menu, the selected test plan is extracted and modified to or just updated from an existing plan. Update/create The test plan is created or updated by concatenating the xml file with the text document. This is then preferably saved in database 399. From this the test plan document is produced (396).

Attention is now directed to the work flow shown in FIG. 3D which is an expansion of block 320 shown in FIG. 3A. Via menu, one or more Use Cases are extracted in accordance with selection criteria specified by a user. If needed the file is modified and/or updated. The newly updated or modified file 386 is provided to duplicate block 386 shown in FIG. 3C.

FIG. 3C depicts that part of the process of the present invention most heavily involved with searching for existing scenarios to be either used as they are or modified. Block 364 has as inputs Use Case xml file 386 and a file containing a list of non-existing scenarios that are “up for” creation. Block 366 asks the question as to whether or not a desirable test element, sequence of test element, or hierarchy of test elements is available (exists). If it isn't available, control flow passes to block 370 where it is further determined if it is possible to select a test element that is similar and to thus make modifications to it in order to produce a desirable test element. In doing so, data is exchanged with Use Case xml database file 374. In block 370 database file 374 is viewed via user driven menu options for similar test elements. If one is found, that is a desirable outcome. If a close one is found it is typically modified at that point in time by a user and restored into database file 374 for later use by others or even by the current user for immediate purposes or for later use.

If test block 366 produces a positive answer, an existing scenario has been located. Corresponding data is extracted from xml database file 374 and it is updated with the xml file (block 376). This is then merged into a single xml file and stored into the appropriate Use Case xml database 380. The question is then asked as to whether or not the test case xml file came originally from off-page reference numeral 4 (see FIG. 3D and block 386). If the answer is in the affirmative control passes to block 341 in FIG. 3B via off-page reference numeral 5. If the answer is in the negative, the use of this flow path portion of the tool is typically ended.

FIG. 3B is a logical continuation from block 382 in FIG. 3C via off-page reference numeral 5. FIG. 3B is a also logical continuation from block 372 in FIG. 3C via off-page reference numeral 6. Additionally, the process flow shown in FIG. 3B also possesses its own independent entry point into block 342. Block 342 provides a menu driven mechanism for inputting Use Case information. In particular, This information contains header data and it creates an association between xml files and text files. Based upon user menu selection in block 342 a use Case text file 359 may be created immediately. Otherwise, the menu system allows the inputting 344 of additional scenarios if needed or desired. For each of these scenarios a database search for a “test” scenario is undertaken. If no scenario is found, it is added (block 350) to a list of missing scenarios which is then written to a file listing non-existing scenarios (block 352). If the scenario is found, Use Case xml file is accessed (356) and it is concatenated into the text file 359.

While the invention has been described in detail herein in accordance with certain preferred embodiments thereof, many modifications and changes therein may be effected by those skilled in the art. Accordingly, it is intended by the appended claims to cover all such modifications and changes as fall within the true spirit and scope of the invention.

What is claimed is:

1. A method for creating software test sequences from a Use Case specification, said method comprising the steps of:
searching a first database which stores previously specified Use Case test elements in at least two hierarchical levels so as to identify existing test elements which are usable as part of a scenario based test design;
based on the content of said first database, selecting at least one test element from one of said at least two hierarchical levels for use in scenario based tests;
creating a test plan, from said at least one selected test element, which invokes test operations on said scenario based test design.

2. The method of claim 1 in which existing elements are found and identified as being a modifiable but usable variant test element.

3. The method of claim 1 in which said searching is carried out at a specified level in said hierarchy.

4. The method of claim 1 in which said searching is carried out through the use of a menu.

5. The method of claim 1 in which there are a plurality of test elements selected.

6. The method of claim 5 in which said plurality of test elements are stored in said first database for later use.

7. A computer readable medium containing instructions thereon for creating software test sequences from a Use Case specification using the steps of:
searching a first database which stores previously specified Use Case test elements in at least two hierarchical levels so as to identify existing test elements which are usable as part of a scenario based test design;
based on the content of said first database, selecting at least one test element from one of said at least two hierarchical levels for use in scenario based tests;
creating a test plan, from said at least one selected test element, which invokes test operations on said scenario based test design.

8. A method for enhancing a database of test sequences generated from a Use Case specification, said method comprising the steps of:
searching through said Use Case specification to identify at least partially corresponding test elements in said database of test elements existing at a plurality of at least two hierarchical levels in said database;
determining suitability for modification of said at least partially corresponding test elements; and
storing modified ones of said test elements in said database, whereby said database of test elements is expanded in a dynamic fashion for more flexible future use.

9. A method for creating software test sequences from a Use Case specification, said method comprising the steps of:
searching through said Use Case specification to identify at least partially corresponding test elements in a database of test elements existing at a plurality of at least two hierarchical levels in said database;
determining suitability for modification of said at least partially corresponding test elements; and
storing modified ones of said test elements in said database, whereby said database of test elements is expanded in a dynamic fashion for more flexible future use.
